(19) United States
(12) Patent Application Publication
(10) Pub. No.: US 2025/0130398 A1
(43) Pub. Date: Apr. 24, 2025

(54) MULTIFOCAL LENS, PROJECTOR, AND IMAGING APPARATUS

(71) Applicant: Seiko Epson Corporation, Tokyo (JP)

(72) Inventors: Masakazu KAWAMURA, Azumino-shi (JP); Hitoshi Hirano, Suwa-shi (JP)

(73) Assignee: Seiko Epson Corporation, Tokyo (JP)

(21) Appl. No.: 18/919,752

(22) Filed: Oct. 18, 2024

(30) Foreign Application Priority Data
Oct. 19, 2023 (JP) 2023-180073

(51) Int. Cl. G02B 9/64; G02B 13/00; G02B 13/02

(52) U.S. Cl. CPC G02B 9/64; G02B 13/006; G02B 13/02

(57) ABSTRACT

A multifocal lens is configured with multiple lens groups and has a focal position changed by changing the positions of the lens groups, and the chromatic aberration of magnification of the multifocal lens is characterized in that the larger one of the amount of aberration at the wide angle end and the amount of aberration at the telephoto end is smaller than the amount of aberration in an intermediate region between the wide angle end and the telephoto end.

The present application is based on, and claims priority from JP Application Serial Number 2023-180073, filed Oct. 19, 2023, the disclosure of which is hereby incorporated by reference herein in its entirety.

### BACKGROUND

### 1. Technical Field

The present disclosure relates to a multifocal lens operable with multiple focal lengths, a projector including the multifocal lens, and an imaging apparatus including the multifocal lens.

### 2. Related Art

There is a known projection-type varifocal lens for a projector including a first lens group including one or two lenses, a second lens group including two lenses, and a third lens group including three lenses with the first lens group fixed, and the second lens group and the third lens group independently moved at the time of zooming (JP-A-2011-053507).

JP-A-2011-053507 is an example of the related art.

The projection-type varifocal lens described above has relatively satisfactory aberration characteristics at the wide angle end, an intermediate position, and the telephoto end, but has a large overall lens length compared with the image height, and has a large total lens length compared with the size of the image display surface.

### SUMMARY

A multifocal lens according to an aspect of the present disclosure is a multifocal lens configured with multiple lens groups and having a focal position changed by changing positions of the lens groups, and chromatic aberration of magnification of the multifocal lens is characterized in that a larger one of the amount of aberration at a wide angle end and the amount of aberration at a telephoto end is smaller than the amount of aberration in an intermediate region between the wide angle end and the telephoto end.

A projector according to another aspect of the present disclosure incudes the multifocal lens described above, and an image forming section configured to form a projection image in a reduction-side conjugate plane of the multifocal lens, and the image forming section includes a light source apparatus and a light modulator configured to modulate light from the light source apparatus.

An imaging apparatus according to another aspect of the present disclosure incudes the multifocal lens described above, and an imager disposed in a reduction-side conjugate plane of the multifocal lens.

### BRIEF DESCRIPTION OF THE DRAWINGS

FIG. 1 illustrates a projector including a multifocal lens according to a first embodiment.

FIG. 2 shows the configuration of the multifocal lens according to the first embodiment and is a beam diagram showing beams passing through the multifocal lens.

FIG. 3 shows the configuration of a multifocal lens according to Example 1.

FIG. 4 illustrates zooming operation of the multifocal lens according to Example 1.

FIG. 5 shows the characteristics of the chromatic aberration of magnification of the multifocal lens according to Example 1.

FIG. 6 shows the characteristics of the longitudinal aberrations of the multifocal lens according to Example 1.

FIG. 7 shows the configuration of a multifocal lens according to Example 2.

FIG. 8 illustrates zooming operation of the multifocal lens according to Example 2.

FIG. 9 shows the characteristics of the chromatic aberration of magnification of the multifocal lens according to Example 2.

FIG. 10 shows the characteristics of the longitudinal aberrations of the multifocal lens according to Example 2.

FIG. 11 shows the configuration of a multifocal lens according to Example 3.

FIG. 12 illustrates zooming operation of the multifocal lens according to Example 3.

FIG. 13 shows the characteristics of the chromatic aberration of magnification of the multifocal lens according to Example 3.

FIG. 14 shows the characteristics of the longitudinal aberrations of the multifocal lens according to Example 3.

FIG. 15 illustrates an imaging apparatus including a multifocal lens according to a second embodiment.

### DESCRIPTION OF EMBODIMENTS

### First Embodiment

A multifocal lens according to a first embodiment of the present disclosure and a projector incorporating the multifocal lens will be described below with reference to the drawings.

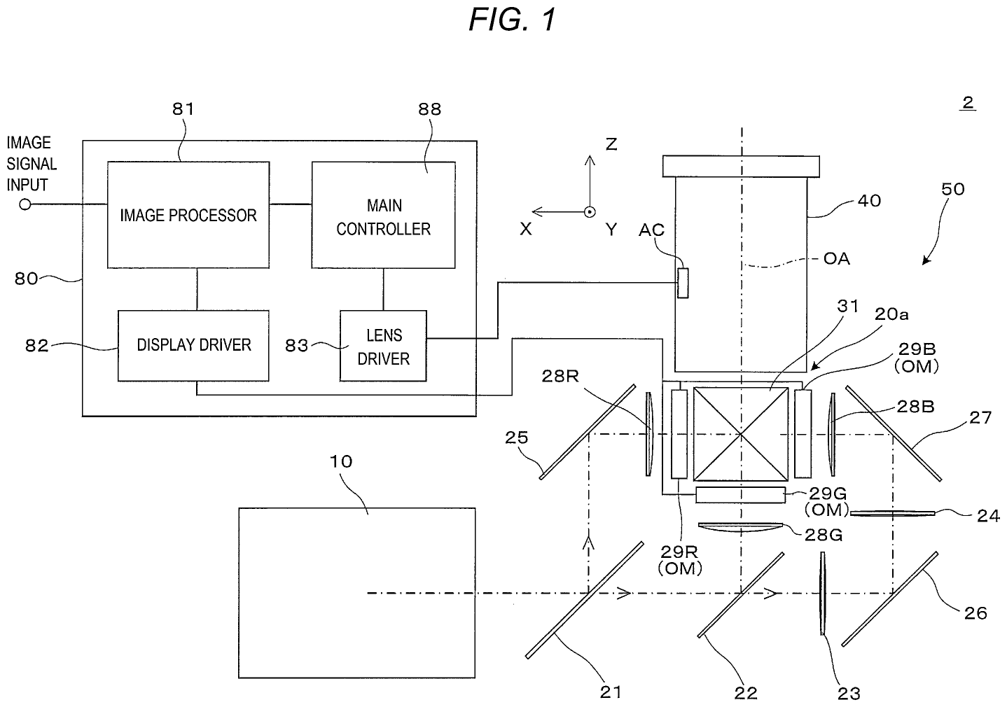

A projector 2, which incorporates a multifocal lens 40 according to the first embodiment, includes an optical system section 50, which projects image light, and a circuit apparatus 80, which controls the operation of the optical system section 50, as shown in FIG. 1.

In the optical system section 50, a light source apparatus 10 outputs homogenized light containing R light, G light, and B light. The light source apparatus 10 includes a light source lamp that is, for example, an ultrahigh-pressure mercury lamp, a two-stage optical integration lens including multiple lens elements arranged in an array, a polarization converter that converts the light having passed through the two-stage optical integration lens into predetermined linearly polarized light, and a superimposing lens that superimposes illumination light output from the second-stage optical integration lens on display regions of liquid crystal panels 29R, 29G, and 29B.

A first dichroic mirror 21 reflects the R light incident from the light source apparatus 10 and transmits the G light and the B light. The R light reflected off the first dichroic mirror 21 enters the liquid crystal panel 29R, which is a light modulator OM, via a reflection mirror 25 and a field lens 28R. The liquid crystal panel 29R modulates the R light in accordance with an image signal to form an R image.

A second dichroic mirror 22 reflects the G light from the first dichroic mirror 21 and transmits the B light. The G light reflected off the second dichroic mirror 22 enters the liquid crystal panel 29G, which is the light modulator OM, via a field lens 28G. The liquid crystal panel 29G modulates the G light in accordance with an image signal to form a G image. The B light having passed through the second dichroic mirror 22 travels via relay lenses 23 and 24, reflection mirrors 26 and 27, and a field lens 28B, and enters the liquid crystal panel 29B, which is the light modulator OM. The liquid crystal panel 29B modulates the B light in accordance with an image signal to form a B image.

A cross dichroic prism 31 is a prism for light combination, and combines the light modulated by the liquid crystal panel 29R, the light modulated by the liquid crystal panel 29G, and the light modulated by the liquid crystal panel 29B with one another into image light, and causes the image light to travel to the multifocal lens 40.

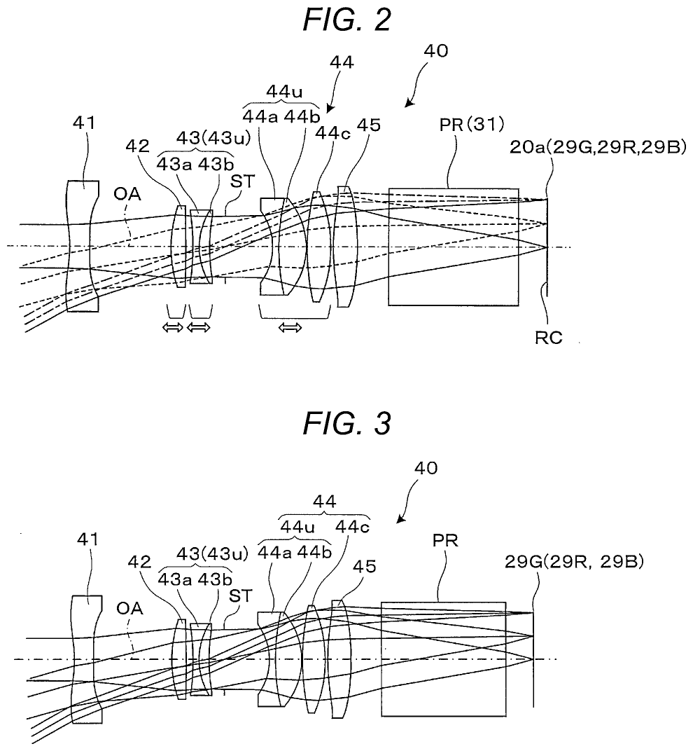

The multifocal lens 40 is a projection lens that enlarges the image light as a result of the modulation performed by the liquid crystal panels 29R, 29G, and 29B and the light combination performed by the cross dichroic prism 31 and projects the enlarged image light onto a screen that is not shown. The liquid crystal panels 29R, 29G, and 29B form an image forming section 20a, which forms a projection image in a reduction-side conjugate plane RC (see FIG. 2 described later) of the multifocal lens 40.

The circuit apparatus 80 includes an image processor 81, to which an external image signal such as a video signal is input, a display driver 82, which drives the liquid crystal panels 29R, 29G, and 29B provided in the optical system section 50 based on an output from the image processor 81, a lens driver 83, which adjusts the state of the multifocal lens 40 by operating a driving mechanism (not shown) provided in the multifocal lens 40, and a main controller 88, which harmoniously controls the operation of the circuit sections 81, 82, and 83, and the like.

The image processor 81 converts the input external image signal into image signals containing grayscales and other factors for the respective colors. The image processor 81 can also perform various types of image processing such as distortion correction and color correction on the external image signal.

The display driver 82 can operate the liquid crystal panels 29R, 29G, and 29B based on the image signals output from the image processor 81, and can cause the liquid crystal panels 29R, 29G, and 29B to form images corresponding to the image signals or images corresponding to the image signals on which the image processing has been performed.

The lens driver 83 operates under the control of the main controller 88, and can change the state of the multifocal lens 40 from the state at the wide angle end to the state at the telephoto end and vice versa by appropriately moving some of the optical elements that constitute the multifocal lens 40 along an optical axis OA via an actuator AC. In this process, the lens groups to be moved can be individually moved, or can be moved in coordination with each other by using a cam mechanism. When the zooming is motorized by using the actuator AC, the state of the multifocal lens 40 can be smoothly switched from the state at the wide angle end to the state at the telephoto end and vice versa in a binary manner, so that a user can use the projector with reduced stress.

The actuator AC and other elements described above can be omitted. That is, some of the optical elements that constitute the multifocal lens 40 may be manually moved with a mechanical mechanism including a cam mechanism or the like to switch the state of the multifocal lens 40 between the state at the wide angle end to the state at the telephoto end.

The lens driver 83 may automatically adjust the focus state of the multifocal lens 40. The lens driver 83 may change the vertical position of the image projected onto the screen or the state of the image projected onto the screen through tilt adjustment in which the entire multifocal lens 40 is moved in the upward/downward direction perpendicular to the optical axis OA.

The multifocal lens 40 according to the embodiment will be specifically described below with reference to FIG. 2. Note that the multifocal lens 40 shown in FIG. 2 by way of example has the same configuration as the multifocal lens 40 according to Example 1, which will be described later.

The multifocal lens 40 according to the embodiment projects the image formed at a projection receiving surface of the liquid crystal panel 29G (29R, 29B) onto the screen that is not shown. A prism PR corresponding to the cross-dichroic prism 31 in FIG. 1 is disposed between the multifocal lens 40 and the liquid crystal panel 29G (29R, 29B).

The multifocal lens 40 includes a first lens group 41 having negative refractive power, a second lens group 42 having positive refractive power, a third lens group 43 having negative refractive power, a fourth lens group 44 having positive refractive power, and a fifth lens group 45 having positive refractive power, the lens groups sequentially arranged from the side facing the screen, which is the enlargement side. In the multifocal lens 40, the second lens group 42 to the fourth lens group 44 are moved at the time of zooming. At the time of zooming that increases the focal length, the second lens group 42 to the fourth lens group 44 are moved from the reduction side toward the enlargement side with the distances between adjacent lens groups being changed. That is, the second lens group 42 to the fourth lens group 44 are moved in the direction away from the liquid crystal panel 29G (29R, 29B) but toward the screen. In this process, the first lens group 41 and the fifth lens group 45 are fixed, and a substantially telecentric state is maintained at the reduction side, that is, the side facing the liquid crystal panel 29G (29R, 29B).

In the multifocal lens 40, the first lens group 41 is a negative aspherical lens made of a plastic material, and the second lens group 42 is a biconvex lens. The third lens group 43 is a cemented lens 43u including a biconcave lens 43a and a positive meniscus lens 43b sequentially arranged from the enlargement side and bonded to each other. The fourth lens group 44 includes a cemented lens 44u and a biconvex lens 44c sequentially arranged from the enlargement side, and the cemented lens 44u includes a biconcave lens 44a and a biconvex lens 44b sequentially arranged from the enlargement side and bonded to each other. The fifth lens group 45 is a positive aspherical lens made of a plastic material. The second lens group 42 to the fourth lens group 44 are made of glass.

The multifocal lens 40 is substantially telecentric at the object side or the reduction side of the liquid crystal panel 29G (29R, 29B). Therefore, when the multiple types of light modulated by the liquid crystal panels 29G, 29R, and 29B are combined with one another in the cross dichroic prism 31 into image light, the light to be combined can be used at increased efficiency, and variation in element assembly can be readily eliminated.

The multifocal lens 40 includes an aperture stop ST between the third lens group 43 and the fourth lens group 44, and the aperture stop ST is moved along with the third lens group 43 or the fourth lens group 44.

In the multifocal lens 40 according to the embodiment, the first lens group 41 has negative refractive power, and the second lens group 42 and the subsequent lens groups have positive refractive power as a whole, so that a wide viewing angle can be achieved with no increase in the diameter of the first lens group 41, and the back focal length of the multifocal lens 40 can be increased. In addition, the chromatic aberration of magnification produced by the first lens group 41 can be corrected by the second lens group 42, the positive chromatic aberration of magnification produced by the fourth lens group 44 and the fifth lens group 45 can be corrected by the negative power of the third lens group 43, and the telecentricity of the portion facing the reduction side of the fifth lens group 45 can be secured by the fourth lens group 44 and the fifth lens group 45, so that satisfactory aberration characteristics can be achieved.

In the multifocal lens 40 according to the embodiment, at the time of zooming, the first lens group 41 and the fifth lens group 45 are fixed, and the second lens group 42, the third lens group 43, and the fourth lens group 44 are moved independently of each other from the reduction side toward the enlargement side in the wide-angle-end-to-telephoto-end transition, which increases the focal length of the multifocal lens 40, and the second lens group 42, the third lens group 43, and the fourth lens group 44 are moved in the opposite direction of the direction described above in the telephoto-end-to-wide-angle-end transition, which decreases the focal length of the multifocal lens 40. At the time of zooming, since the first lens group 41 and the fifth lens group 45 are fixed, and only the second lens group 42 to the fourth lens group 44 are moved independently of each other, the overall length of the multifocal lens 40 does not change, and the structure of the lens barrel that holds the multifocal lens 40 can be simplified.

In the multifocal lens 40 according to the embodiment, the chromatic aberration of magnification is characterized in that the larger one of the amount of aberration at the wide angle end and the amount of aberration at the telephoto end is smaller than the amount of aberration in an intermediate region between the wide angle end and the telephoto end. In the above description, the intermediate region means a state of the multifocal lens 40 performing zooming and having a focal length that is the average of the focal length at the wide angle end and the focal length at the telephoto end. The amount of aberration at the wide angle end or the telephoto end means the largest absolute value of the amount of aberration produced within the range of a target image height. The shortest blue wavelength and the longest red wavelength are taken into consideration for the characteristics of the chromatic aberration of magnification. Specifically, it is assumed that the blue wavelength is 470 nm and the red wavelength is 620 nm. In the optical system that achieves the aforementioned characteristics of the chromatic aberration of magnification, the power of each of the lens groups 41, 42, 43, 44, and 45 can be increased, so that the travels of the lens groups 42, 43, and 44 moved to achieve multiple focal points can be suppressed. As a result, the performance of the multifocal lens 40 can be maintained with an increase in the total length of the multifocal lens 40, that is, the lens length suppressed, and the size of the multifocal lens 40 can be further reduced.

In the multifocal lens 40 according to the embodiment, the spherical aberration is characterized in that the larger one of the amount of aberration at the wide angle end and the amount of aberration at the telephoto end is smaller than the amount of aberration in an intermediate region between the wide angle end and the telephoto end. In the above description, the intermediate region is defined in the same manner as the intermediate region for the characteristics of the chromatic aberration of magnification. The amount of aberration at the wide angle end or the telephoto end means the largest absolute value of the amount of aberration produced within the range of a target image height. The shortest blue wavelength and the longest red wavelength are taken into consideration for the characteristics of the spherical aberration, as in the case of the characteristics of the chromatic aberration of magnification. In the optical system that achieves the aforementioned characteristics of the spherical aberration, the lens power of each of the lens groups 41, 42, 43, 44, and 45 can be increased, so that the size of the multifocal lens 40 can be further reduced. In particular, better aberration characteristics can be achieved at the wide angle end and the telephoto end. In the multifocal lens 40 according to the embodiment, the astigmatism is characterized in that the larger one of the amount of aberration at the wide angle end and the amount of aberration at the telephoto end, for example, the amount of aberration at the telephoto end is smaller than the amount of aberration in the intermediate region between the wide angle end and the telephoto end. In the optical system that achieves the aforementioned characteristics of the astigmatism, the lens power of each of the lens groups 41, 42, 43, 44, and 45 can be increased, so that the size of the multifocal lens 40 can be further reduced. In particular, better aberration characteristics can be achieved at the wide angle end and the telephoto end.

Attention has been given to the intermediate region between the wide angle end and the telephoto end in the above description, and even in a quasi-intermediate region that is an intermediate region shifted toward the wide angle end or an intermediate region shifted toward the telephoto end, the chromatic aberration of magnification, the spherical aberration, and the astigmatism are each more desirably characterized in that the larger one of the amount of aberration at the wide angle end and the amount of aberration at the telephoto end is smaller than the amount of aberration in the quasi-intermediate region.

In the multifocal lens 40 according to the embodiment, the ratio ft/fw is greater than or equal to 1.20, where fw represents the focal length of the entire system operating at the wide angle end, and ft represents the focal length of the entire system operating at the telephoto end. The thus configured multifocal lens 40 is a compact optical system including the multifocal lens 40 having a short total length with respect to the image height, and having an increased focal length difference that is a difference in the focal length between the wide angle end and the telephoto end.

The multifocal lens 40 according to the embodiment satisfies the conditional expression below.

$$1. \leq \vert fG 1 / fG 2 \vert \qquad ( 1 )$$

In the expression, the value fG1 is the focal length of the first lens group 41, and the value fG2 is the focal length of the second lens group 42. Making the power of the second lens group 42 equal to or greater than that of the first lens group 41, that is, increasing the multifocal length difference (difference in magnification) as described above contributes to a decrease in the total length.

The value |fG1/fG2| in Conditional Expression (1) described above may be

$$1. 3 \leq \vert fG 1 / fG 2 {\vert}^{′} \qquad ( 1 )$$

from the viewpoint of a decrease in the overall length.

The value |fG1/fG2| may satisfy

$$1. \leq \vert fG 1 / fG 2 \vert \leq {1.5}^{″} \qquad ( 1 )$$

from the viewpoint of avoiding increases in the variety of aberrations.

The multifocal lens 40 according to the embodiment satisfies the conditional expression below.

$$0.1 \leq M 4 / LL \leq 0.35 \qquad ( 2 )$$

In the expression, the value M4 represents the travel of the fourth lens group 44 from the wide angle end to the telephoto end, and the value LL represents the lens length. Making the travel of the fourth lens group 44 relatively large as described above can contribute to a decrease in the entire length while increasing the multifocal length difference (difference in magnification). Setting the value M4/LL in Conditional Expression described above to be greater than or equal to the lower limit readily increases the multifocal length difference (difference in magnification). Setting the value M4/LL in Conditional Expression described above to be smaller than or equal to the upper limit can avoid the problems of an increase in the overall length and increases in the variety of aberrations. The state in which the aperture stop ST is disposed between the third lens group 43 and the fourth lens group 44 and the travel of the fourth lens group 44 is large can be typically taken as a large travel of the portion downstream from the aperture stop ST, that is, the reduction-side portion of the multifocal lens 40.

The value M4/LL may satisfy

$$0.2 \leq M 4 / LL \leq {0.35}^{′} . \qquad ( 2 )$$

The multifocal lens 40 according to the embodiment satisfies the conditional expression below.

$$AVvd 1 / AVvd 2 \leq 0.80 \qquad ( 3 )$$

In the expression, the value AVνd1 represents an average Abbe number of the first lens group 41 at the d-line, and the value AVνd2 represents an average Abbe number of the second lens group 42 at the d-line. That is, the second lens group 42 is made of a material having a low Abbe number. The chromatic aberration of magnification (relatively large due to large change in angle of beam) generated by the first lens group 41 can be effectively corrected by the second lens group 42 characterized by large dispersion. Accordingly, the size reduction can be achieved with the chromatic aberration effectively corrected. When the second lens group 42 is a single lens, the size reduction can be more readily achieved.

The value AVνd1/AVνd2 may satisfy

$$AVvd 1 / AVvd 2 \leq {0.7}^{′} . \qquad ( 3 )$$

The multifocal lens 40 according to the embodiment satisfies the conditional expression below.

$$LL / HI \leq 8. \qquad ( 4 )$$

In the expression, the value LL represents the lens length, and the value HI represents the image height. Satisfying Conditional Expression (4) described above can contribute to the reduction in the size of the multifocal lens 40.

The value LL/HI may satisfy

$$LL / HI \leq {6.}^{′} . \qquad ( 4 )$$

As described above, the multifocal lens 40 according to the embodiment is a multifocal lens configured with the multiple lens groups 42, 43, and 44 and having a focal position changed by changing the positions of the lens groups 42, 43, and 44, and the chromatic aberration of magnification of the multifocal lens 40 is characterized in that the larger one of the amount of aberration at the wide angle end and the amount of aberration at the telephoto end is smaller than the amount of aberration in the intermediate region between the wide angle end and the telephoto end.

In the optical system that achieves the aforementioned characteristics of the chromatic aberration of magnification, the power of each of the lens groups can be increased, so that the travels of the lens groups 41, 42, 43, 44, and 45 for achieving multiple focal points can be suppressed. As a result, the performance of the multifocal lens 40 can be maintained with an increase in the total length of the multifocal lens 40, that is, the lens length suppressed with respect to the image height, so that the size of the multifocal lens 40 can be further reduced.

As described above, the projector 2 according to the embodiment includes the multifocal lens 40 described above and the image forming section 20a, which forms a projection image in the reduction-side conjugate plane RC of the multifocal lens 40, and the image forming section 20a includes the light source apparatus 10 and the light modulator OM, which modulates the light from the light source apparatus 10. The size of the projector 2 including the multifocal lens 40 can thus be reduced.

### EXAMPLES

Examples of the multifocal lens 40, which is the projection lens, will be described below. The meanings of parameters common to Examples 1 to 3 described below are summarized below.
R Radius of curvature
D Axial inter-surface spacing
   (lens thickness or spacing between lenses)
Nd Refractive Index at d-Line
Vd Abbe number at d-line

An aspherical surface is specified by the following polynomial equation (aspherical equation).

$$z = \frac{c {h}^{2}}{1 + \sqrt{1 − ( k + 1 ) {c}^{2} {h}^{2}}} + \sum {A}_{i} {h}^{i}$$

where
c: Curvature (1/R)
H: Height from optical axis
K: Conical coefficient of aspherical surface
Ai: high-order aspherical coefficient of aspherical surface

The surface number 0 means the image plane (projection receiving surface) on the screen, STO means the aperture stop ST, and the last surface number means the display surface such as the liquid crystal panel 29G. A surface number followed by “*” is an aspherical surface.

### Example 1

Data on the lens surfaces in Example 1 are shown in Table 1 below.

TABLE 1

| Surface | | | | |
|---|---|---|---|---|
| number | R | D | Nd | Vd |
| 0 | Infinity | 1800.00 | | |
| 1* | −22.008 | 3.8000 | 1.535038 | 55.7111 |
| 2* | −1143.411 | 15.5639 | | |
| 3 | 26.549 | 2.8288 | 1.834000 | 37.1611 |
| 4 | −268.704 | 1.3578 | | |
| 5 | −49.396 | 1.2000 | 1.720467 | 34.7081 |
| 6 | 14.193 | 2.0000 | 1.922860 | 20.8801 |
| 7 | 39.656 | 3.0000 | | |
| 8(STO) | Infinity | 8.9987 | | |
| 9 | −12.340 | 1.2000 | 1.728250 | 28.4611 |
| 10 | 45.593 | 5.2020 | 1.552001 | 70.6971 |
| 11 | −14.918 | 0.1824 | | |
| 12 | 51.483 | 4.5087 | 1.528411 | 76.4531 |
| 13 | −28.571 | 0.5000 | | |
| 14* | 46.024 | 4.6577 | 1.535038 | 55.7111 |
| 15* | −55.733 | 6.0000 | | |
| 16 | Infinity | 24.7200 | 1.516331 | 64.1421 |
| 17 | Infinity | 5.5034 | | |
| 18 | Infinity | −0.0300 | | |

Table 2 below shows the values of the axial inter-surface spacing D at variable spacing locations in Example 1 out of those between the lens surfaces of the multifocal lens operating at the wide angle end (wide), the intermediate position (middle), and the telephoto end (tele).

TABLE 2

| Surface | | | |
|---|---|---|---|
| number | wide | middle | tele |
| 2 | 15.564 | 11.993 | 5.251 |
| 4 | 1.358 | 4.914 | 7.450 |
| 7 | 3.000 | 0.738 | 1.000 |
| 8 | 8.999 | 4.237 | 4.229 |
| 13 | 0.500 | 8.696 | 11.490 |
| 17 | 5.503 | 4.316 | 5.396 |

Table 3 below shows the aspherical coefficients of the lens surfaces in Example 1.

TABLE 3
Aspherical coefficients

| Surface number | R | K | A4 | A6 | A8 |
|---|---|---|---|---|---|
| 1 | −2.200800E+01 | 0.000000 | 3.050208E−04 | −2.546031E−06 | 2.112792E−08 |
| 2 | −1.143411E+03 | 0.000000 | 2.817394E−04 | −2.311550E−06 | 3.483659E−08 |
| 14 | 4.602400E+01 | −80.000000 | 9.304468E−05 | −1.930132E−06 | 2.756054E−08 |
| 15 | −5.573300E+01 | −74.263689 | −4.585970E−05 | −1.262879E−09 | 4.270808E−09 |

| Surface number | A10 | A12 | A14 | A16 |
|---|---|---|---|---|
| 1 | −1.452593E−10 | 7.436542E−13 | −2.353712E−15 | 3.304510E−18 |
| 2 | −6.043723E−10 | 6.986117E−12 | −4.227135E−14 | 1.022278E−16 |
| 14 | −2.784933E−10 | 1.682655E−12 | −5.554550E−15 | 7.189776E−18 |
| 15 | −7.120567E−11 | 5.005330E−13 | −1.781539E−15 | 2.290665E−18 |

In Table 3 shown above and the tables shown below, a number to the power of 10 (1.00×10⁺¹⁸, for example) is expressed by using E (1.00E+18, for example).

FIG. 3 is a cross-sectional view of the multifocal lens 40 according to Example 1. The multifocal lens 40 shown in FIG. 3 corresponds to the multifocal lens 40 according to the first embodiment. The multifocal lens 40 has a total length, that is, a lens length of 55 mm, LL/HI≈5.78, and a multifocal length difference of 1.50 times.

The multifocal lens 40 enlarges an image on the display surface, for example, of the liquid crystal panel 29G at a magnification according to the distance to the screen and projects the enlarged image. The multifocal lens 40 includes a first lens group 41 having negative refractive power, a second lens group 42 having positive refractive power, a third lens group 43 having negative refractive power, a fourth lens group 44 having positive refractive power, and a fifth lens group 45 having positive refractive power, the lens groups sequentially arranged from the side facing the screen, which is the enlargement side. The prism PR is disposed between the fifth lens group 45 and the liquid crystal panel 29G.

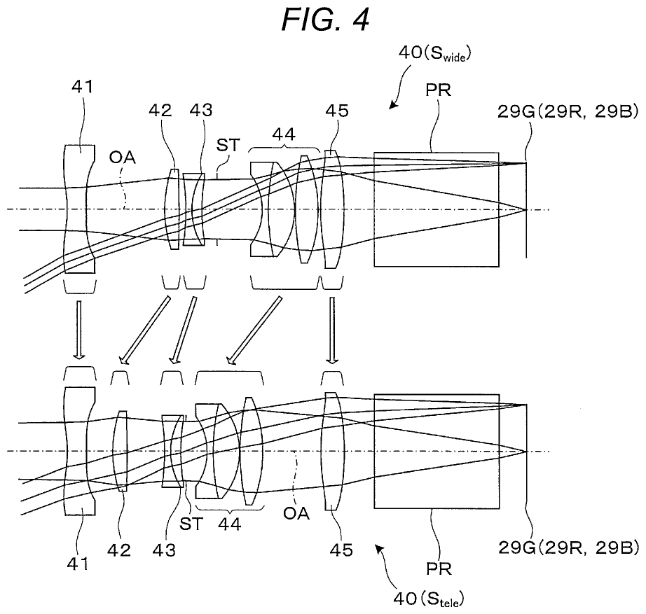

At the time of zooming performed by the multifocal lens 40, the first lens group 41 and the fifth lens group 45 are fixed, and the second lens group 42 to the fourth lens group 44 are moved, with the reduction-side portion of the multifocal lens 40 being substantially telecentric, as shown in FIG. 4. The multifocal lens 40 shown at the upper side operates in a wide-angle-end state S_{wide}, in which the second lens group 42 to the fourth lens group 44 are located at the reduction side close to the liquid crystal panel 29G. The multifocal lens 40 shown at the lower side operates in a telephoto-end state Sₜₑₗₑ, in which the second lens group 42 to the fourth lens group 44, are moved as a whole toward the enlargement side facing the screen with the distances between adjacent lens groups being changed.

Returning to FIG. 3, the first lens group 41 is a negative aspherical lens made of a plastic material, and the second lens group 42 is a biconvex lens. The third lens group 43 is a cemented lens 43u including a biconcave lens 43a and a positive meniscus lens 43b sequentially arranged from the enlargement side and bonded to each other. The fourth lens group 44 includes a cemented lens 44u and a biconvex lens 44c sequentially arranged from the enlargement side, and the cemented lens 44u includes a biconcave lens 44a and a biconvex lens 44b sequentially arranged from the enlargement side and bonded to each other. The fifth lens group 45 is a positive aspherical lens made of a plastic material. The second lens group 42 to the fourth lens group 44 are made of glass.

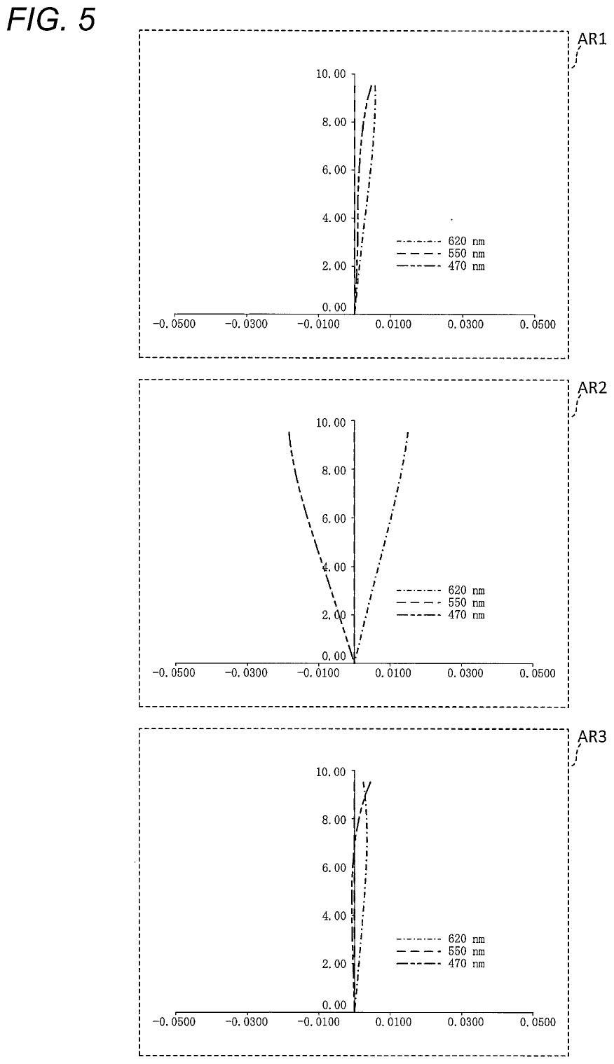

FIG. 5 shows the characteristics of the chromatic aberration of magnification of the multifocal lens according to Example 1. In FIG. 5, a region AR1 shows the characteristics of the chromatic aberration of magnification at the wide angle end (focal length fw=16.50 mm), a region AR2 shows the characteristics of the chromatic aberration of magnification in the intermediate region (focal length fm=20.63 mm), which is the intermediate position, and a region AR3 shows the characteristics of the chromatic aberration of magnification at the telephoto end (focal length ft=24.75 mm). The chromatic aberration of magnification of the multifocal lens according to Example 1 is characterized in that the larger one of the amount of aberration at the wide angle end and the amount of aberration at the telephoto end, that is, the amount of aberration at the wide angle end is smaller than the amount of aberration in the intermediate region between the wide angle end and the telephoto end.

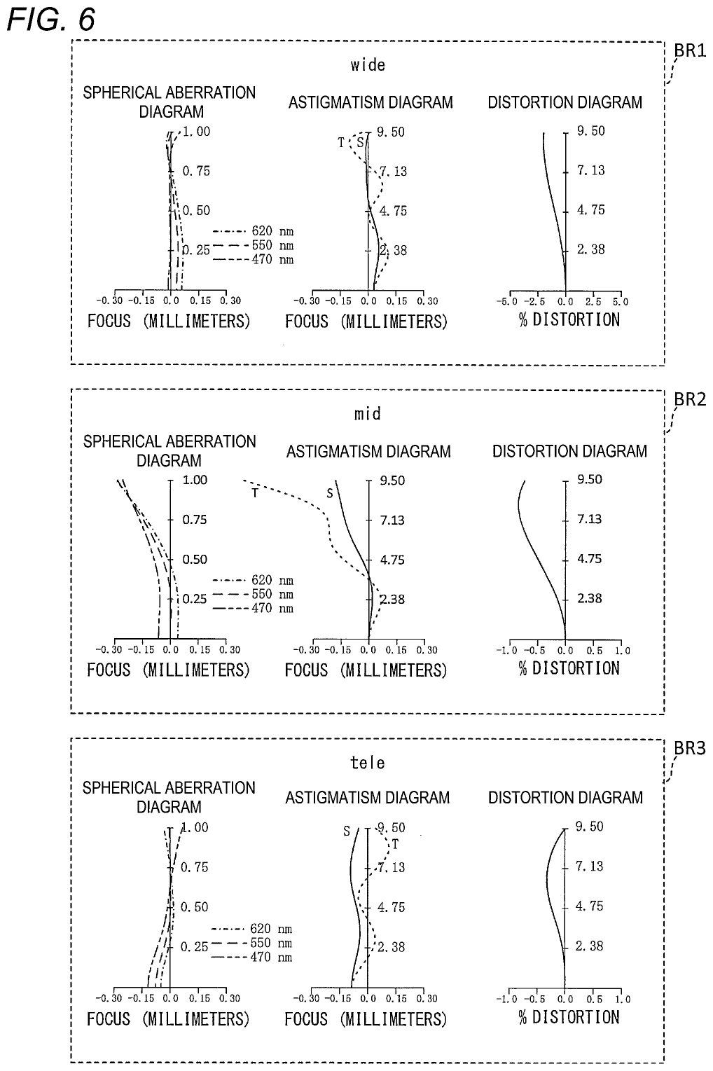

FIG. 6 shows the characteristics of the longitudinal aberrations (that is, characteristics of spherical aberration, astigmatism, and distortion) of the multifocal lens according to Example 1. In FIG. 6, a region BR1 shows the longitudinal aberrations at the wide angle end (focal length fw=16.50 mm), a region BR2 shows the longitudinal aberrations in the intermediate region (focal length fm=20.63 mm), which is the intermediate position, and a region BR3 shows the longitudinal aberrations at the telephoto end (focal length ft=24.75 mm). The spherical aberration of the multifocal lens according to Example 1 is characterized in that the larger one of the amount of aberration at the wide angle end and the amount of aberration at the telephoto end, that is, the amount of aberration at the telephoto end is smaller than the amount of aberration in the intermediate region between the wide angle end and the telephoto end. The astigmatism of the multifocal lens according to Example 1 is characterized in that the larger one of the amount of aberration at the wide angle end and the amount of aberration at the telephoto end, that is, the amount of aberration at the telephoto end is smaller than the amount of aberration in the intermediate region between the wide angle end and the telephoto end.

### Example 2

Data on the lens surfaces in Example 2 are shown in Table 4 below.

TABLE 4

| Surface | | | | |
|---|---|---|---|---|
| number | R | D | Nd | Vd |
| 0 | Infinity | 1800.00 | | |
| 1* | −18.362 | 3.8000 | 1.535038 | 55.7111 |
| 2* | −102.328 | 15.0698 | | |
| 3 | 41.739 | 2.8288 | 1.834000 | 37.1611 |
| 4 | −87.656 | 1.7576 | | |
| 5 | −44.575 | 1.2000 | 1.720467 | 34.7081 |
| 6 | 16.357 | 2.0000 | 1.922860 | 20.8801 |
| 7 | 96.873 | 3.0000 | | |
| 8(STO) | Infinity | 8.5258 | | |
| 9 | −11.054 | 1.2000 | 1.728250 | 28.4611 |
| 10 | 49.176 | 5.2020 | 1.552001 | 70.6971 |
| 11 | −14.688 | 0.1824 | | |
| 12 | 100.294 | 4.5087 | 1.528411 | 76.4531 |
| 13 | −21.488 | 1.0673 | | |
| 14* | 46.045 | 4.6577 | 1.535038 | 55.7111 |
| 15* | −53.528 | 6.0000 | | |
| 16 | Infinity | 24.7200 | 1.516331 | 64.1421 |
| 17 | Infinity | 4.5331 | | |
| 18 | Infinity | −0.0183 | | |

Table 5 below shows the values of the axial inter-surface spacing D at variable spacing locations in Example 2 out of those between the lens surfaces of the multifocal lens operating at the wide angle end (wide), the intermediate position (middle), and the telephoto end (tele).

TABLE 5

| Surface | | | |
|---|---|---|---|
| number | wide | middle | tele |
| 2 | 15.070 | 7.561 | 6.041 |
| 4 | 1.758 | 5.103 | 7.045 |
| 7 | 3.000 | 5.006 | 1.000 |
| 8 | 8.526 | 7.203 | 4.796 |
| 13 | 1.067 | 5.922 | 10.539 |
| 17 | 4.533 | 4.903 | 4.435 |

Table 6 below shows the aspherical coefficients of the lens surfaces in Example 2.

TABLE 6
Aspherical coefficients

| Surface number | R | K | A4 | A6 | A8 |
|---|---|---|---|---|---|
| 1 | −18.362 | 0.000000 | 3.167599E−04 | −2.595590E−06 | 2.136227E−08 |
| 2 | −102.328 | 0.000000 | 2.705639E−04 | −2.400840E−06 | 3.534280E−08 |
| 14 | 46.045 | −86.478980 | 9.842937E−05 | −1.934716E−06 | 2.774638E−08 |
| 15 | 46.045 | −86.478980 | 9.842937E−05 | −1.934716E−06 | 2.774638E−08 |

| Surface number | A10 | A12 | A14 | A16 |
|---|---|---|---|---|
| 1 | −1.441726E−10 | 7.408873E−13 | −2.399098E−15 | 3.486879E−18 |
| 2 | −6.043636E−10 | 6.953034E−12 | −4.216767E−14 | 1.022953E−16 |
| 14 | −2.771542E−10 | 1.681430E−12 | −5.587980E−15 | 7.528435E−18 |
| 15 | −2.771542E−10 | 1.681430E−12 | −5.587980E−15 | 7.528435E−18 |

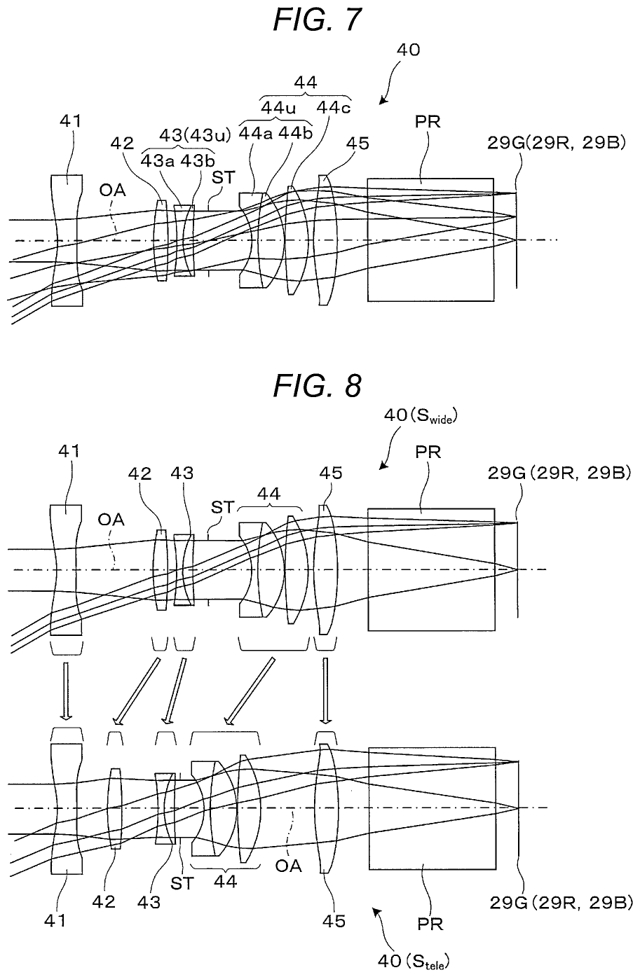

FIG. 7 is a cross-sectional view of the multifocal lens 40 according to Example 2. The multifocal lens 40 has the total length, that is, the lens length of 55 mm, LL/HI≈5.78, and a multifocal length difference of 1.25 times.

The multifocal lens 40 enlarges an image on the display surface, for example, of the liquid crystal panel 29G at a magnification according to the distance to the screen and projects the enlarged image. The multifocal lens 40 includes a first lens group 41 having negative refractive power, a second lens group 42 having positive refractive power, a third lens group 43 having negative refractive power, a fourth lens group 44 having positive refractive power, and a fifth lens group 45 having positive refractive power, the lens groups sequentially arranged from the side facing the screen, which is the enlargement side. The prism PR is disposed between the fifth lens group 45 and the liquid crystal panel 29G.

At the time of zooming performed by the multifocal lens 40, the first lens group 41 and the fifth lens group 45 are fixed, and the second lens group 42 to the fourth lens group 44 are moved, with the reduction-side portion of the multifocal lens 40 being substantially telecentric, as shown in FIG. 8. The multifocal lens 40 shown at the upper side operates in a wide-angle-end state S_{wide}, in which the second lens group 42 to the fourth lens group 44 are located at the reduction side close to the liquid crystal panel 29G. The multifocal lens 40 shown at the lower side operates in a telephoto-end state Sₜₑₗₑ, in which the second lens group 42 to the fourth lens group 44, are moved as a whole toward the enlargement side facing the screen with the distances between adjacent lens groups being changed.

Returning to FIG. 7, the first lens group 41 is a negative aspherical lens made of a plastic material, and the second lens group 42 is a biconvex lens. The third lens group 43 is a cemented lens 43u including a biconcave lens 43a and a positive meniscus lens 43b sequentially arranged from the enlargement side and bonded to each other. The fourth lens group 44 includes a cemented lens 44u and a biconvex lens 44c sequentially arranged from the enlargement side, and the cemented lens 44u includes a biconcave lens 44a and a biconvex lens 44b sequentially arranged from the enlargement side and bonded to each other. The fifth lens group 45 is a positive aspherical lens made of a plastic material. The second lens group 42 to the fourth lens group 44 are made of glass.

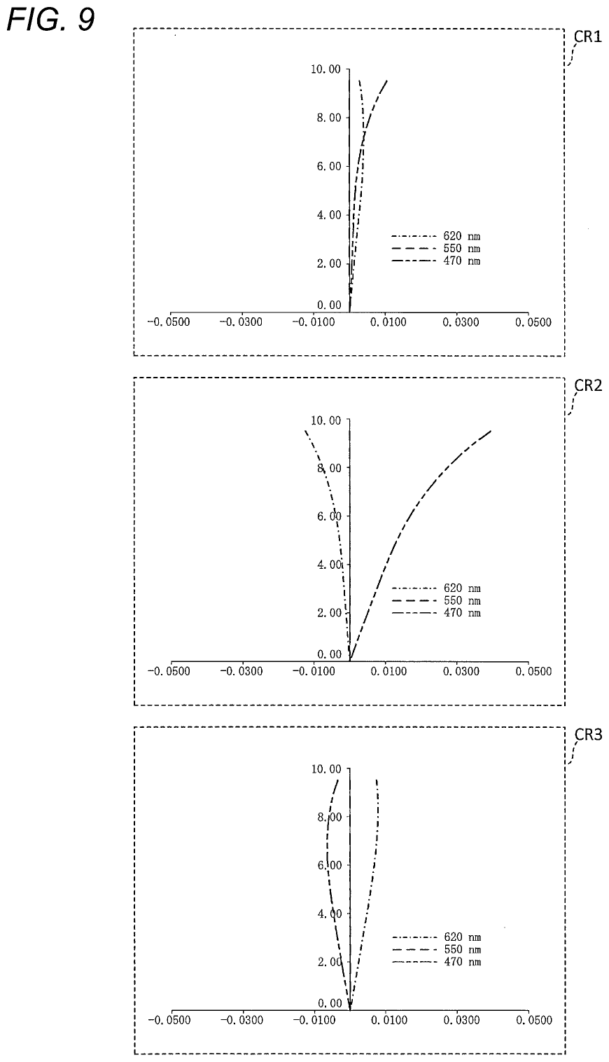

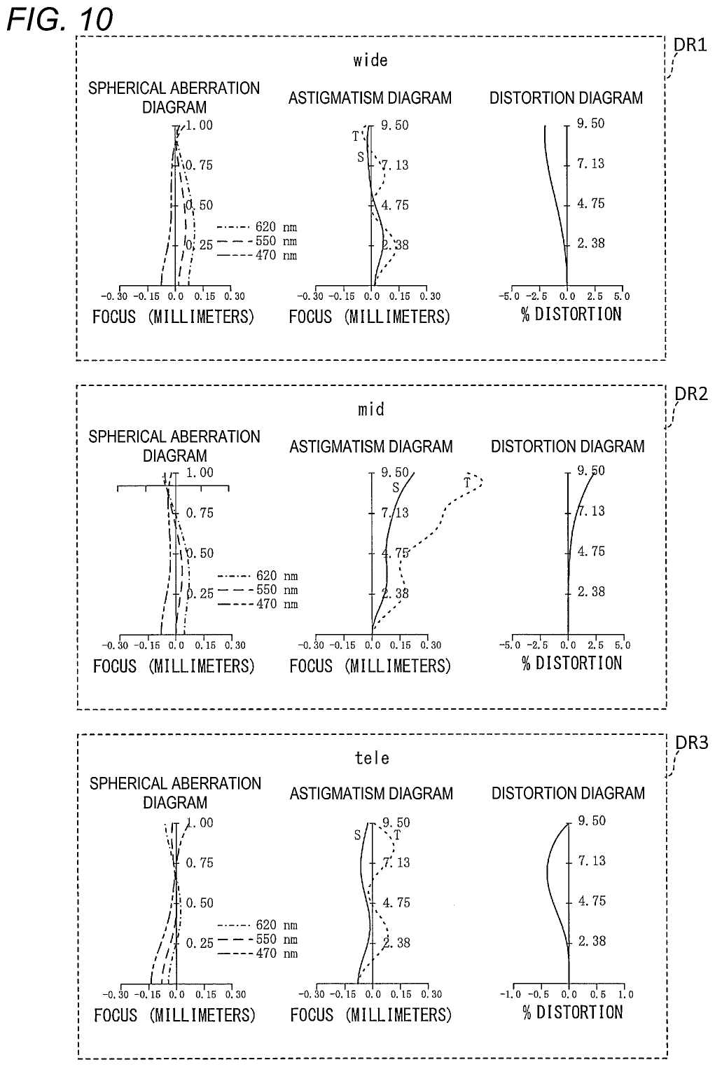

FIG. 9 shows the characteristics of the chromatic aberration of magnification of the multifocal lens according to Example 2. In FIG. 9, a region CR1 shows the characteristics of the chromatic aberration of magnification at the wide angle end (focal length fw=16.50 mm), a region CR2 shows the characteristics of the chromatic aberration of magnification in the intermediate region (focal length fm=18.56 mm), which is the intermediate position, and a region CR3 shows the characteristics of the chromatic aberration of magnification at the telephoto end (focal length ft=20.63 mm). The chromatic aberration of magnification of the multifocal lens according to Example 2 is characterized in that the larger one of the amount of aberration at the wide angle end and the amount of aberration at the telephoto end, that is, the amount of aberration at the telephoto end is smaller than the amount of aberration in the intermediate region between the wide angle end and the telephoto end.

FIG. 10 shows the characteristics of the longitudinal aberrations (that is, characteristics of spherical aberration, astigmatism, and distortion) of the multifocal lens according to Example 2. In FIG. 10, a region DR1 shows the longitudinal aberrations at the wide angle end (focal length fw=16.50 mm), a region DR2 shows the longitudinal aberrations in the intermediate region (focal length fm=18.56 mm), which is the intermediate position, and a region DR3 shows the longitudinal aberrations at the telephoto end (focal length ft=20.63 mm). The spherical aberration and the astigmatism of the multifocal lens according to Example 2 are each characterized in that the larger one of the amount of aberration at the wide angle end and the amount of aberration at the telephoto end is smaller than the amount of aberration in the intermediate region between the wide angle end and the telephoto end.

### Example 3

Data on the lens surfaces in Example 3 are shown in Table 7 below.

TABLE 7

| Surface | | | | |
|---|---|---|---|---|
| number | R | D | Nd | Vd |
| 0 | Infinity | 1800.00 | | |
| 1* | −10.133 | 2.4887 | 1.535038 | 55.7111 |
| 2* | −22.915 | 29.3539 | | |
| 3 | 28.145 | 2.6148 | 1.834000 | 37.1611 |
| 4 | −92.642 | 4.2838 | | |
| 5 | −46.273 | 1.2000 | 1.723420 | 37.9561 |
| 6 | 18.873 | 2.0000 | 1.922860 | 20.8801 |
| 7 | 37.160 | 1.0000 | | |
| 8(STO) | Infinity | 9.6047 | | |
| 9 | −29.859 | 1.2000 | 1.728250 | 28.4611 |
| 10 | 16.595 | 4.6015 | 1.552001 | 70.6971 |
| 11 | −174.231 | 0.1000 | | |
| 12 | 38.008 | 6.6002 | 1.497000 | 81.5461 |
| 13 | −25.039 | 0.5000 | | |
| 14 | −638.475 | 3.0431 | 1.772499 | 49.5981 |
| 15 | −69.320 | 0.1000 | | |
| 16* | 42.824 | 5.0000 | 1.535038 | 55.7111 |
| 17* | −129.505 | 6.0000 | | |
| 18 | Infinity | 24.7200 | 1.516331 | 64.1421 |
| 19 | Infinity | 7.5893 | | |
| 20 | Infinity | 0.0075 | | |

Table 8 below shows the values of the axial inter-surface spacing D at variable spacing locations in Example 3 out of those between the lens surfaces of the multifocal lens operating at the wide angle end (wide), the intermediate position (middle), and the telephoto end (tele).

TABLE 8

| Surface | | | |
|---|---|---|---|
| number | wide | middle | tele |
| 2 | 29.354 | 14.684 | 8.736 |
| 4 | 4.284 | 7.610 | 10.712 |
| 7 | 1.000 | 1.000 | 1.000 |
| 8 | 9.605 | 8.108 | 1.097 |
| 15 | 0.100 | 12.941 | 22.797 |
| 19 | 7.589 | 7.634 | 7.517 |

Table 9 below shows the aspherical coefficients of the lens surfaces in Example 3.

TABLE 9
Aspherical coefficients

| Surface number | R | K | A4 | A6 | A8 | A10 |
|---|---|---|---|---|---|---|
| 1 | −10.133 | −3.538418 | 5.475344E+01 | −2.539242E+02 | 9.168549E+02 | −2.453128E+03 |
| 2 | −22.915 | 0.000000 | 3.504498E+01 | −6.635079E+01 | 4.496130E+01 | 3.478975E+02 |
| 16 | 42.824 | 1.156811 | −2.050272E+00 | −6.937979E+00 | 3.044472E+01 | −1.017974E+02 |
| 17 | −129.505 | 28.206231 | −1.619746E+00 | −6.456633E+00 | 2.981016E+01 | −9.702201E+01 |

| Surface number | A12 | A14 | A16 | A18 |
|---|---|---|---|---|
| 1 | 4.629721E+03 | −5.876214E+03 | 4.704436E+03 | −2.112575E+03 |
| 2 | −1.640489E+03 | 3.678785E+03 | −4.723227E+03 | 3.320749E+03 |
| 16 | 1.805938E+02 | −1.796240E+02 | 7.532349E+01 | 1.619822E+01 |
| 17 | 1.700112E+02 | −1.625106E+02 | 6.355576E+01 | 1.343087E+01 |

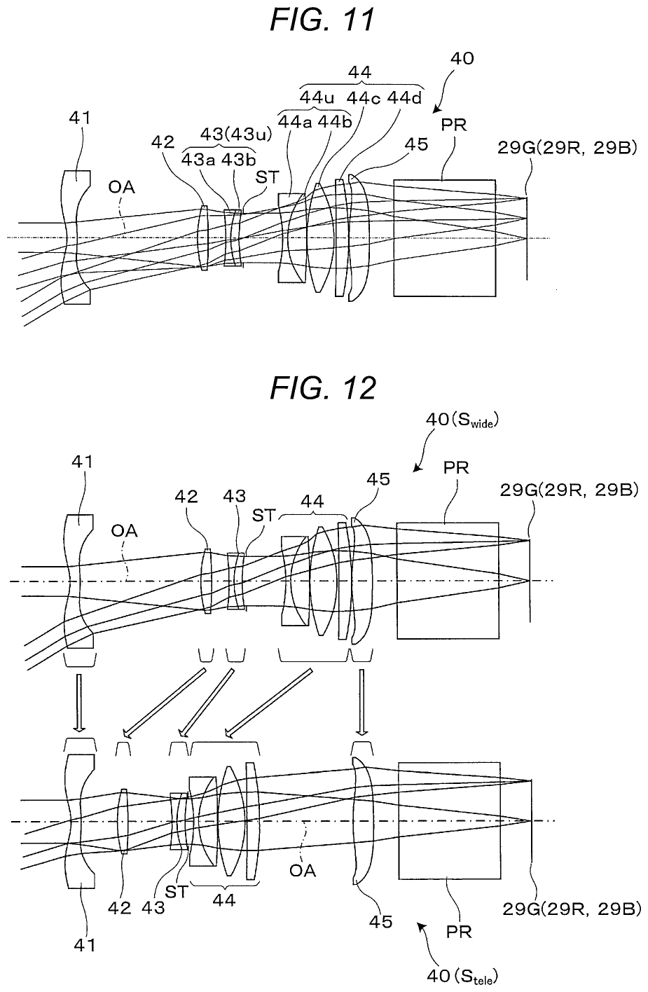

FIG. 11 is a cross-sectional view of the multifocal lens 40 according to Example 3. The multifocal lens 40 has a total length, that is, a lens length of 73.7 mm, LL/HI≈7.75, and a multifocal length difference of 2.00 times.

The multifocal lens 40 enlarges an image on the display surface, for example, of the liquid crystal panel 29G at a magnification according to the distance to the screen and projects the enlarged image. The multifocal lens 40 includes a first lens group 41 having negative refractive power, a second lens group 42 having positive refractive power, a third lens group 43 having negative refractive power, a fourth lens group 44 having positive refractive power, and a fifth lens group 45 having positive refractive power, the lens groups sequentially arranged from the side facing the screen, which is the enlargement side. The prism PR is disposed between the fifth lens group 45 and the liquid crystal panel 29G.

At the time of zooming performed by the multifocal lens 40, the first lens group 41 and the fifth lens group 45 are fixed, and the second lens group 42 to the fourth lens group 44 are moved, with the reduction-side portion of the multifocal lens 40 being substantially telecentric, as shown in FIG. 12. The multifocal lens 40 shown at the upper side operates in a wide-angle-end state S_{wide}, in which the second lens group 42 to the fourth lens group 44 are located at the reduction side close to the liquid crystal panel 29G. The multifocal lens 40 shown at the lower side operates in a telephoto-end state Sₜₑₗₑ, in which the second lens group 42 to the fourth lens group 44, are moved as a whole toward the enlargement side facing the screen with the distances between adjacent lens groups being changed.

Returning to FIG. 11, the first lens group 41 is a negative aspherical lens made of a plastic material, and the second lens group 42 is a biconvex lens. The third lens group 43 is a cemented lens 43u including a biconcave lens 43a and a positive meniscus lens 43b sequentially arranged from the enlargement side and bonded to each other. The fourth lens group 44 includes a cemented lens 44u, a biconvex lens 44c, and a positive meniscus lens 44d sequentially arranged from the enlargement side, and the cemented lens 44u includes a biconcave lens 44a and a biconvex lens 44b sequentially arranged from the enlargement side and bonded to each other. The fifth lens group 45 is a positive aspherical lens made of a plastic material. The second lens group 42 to the fourth lens group 44 are made of glass.

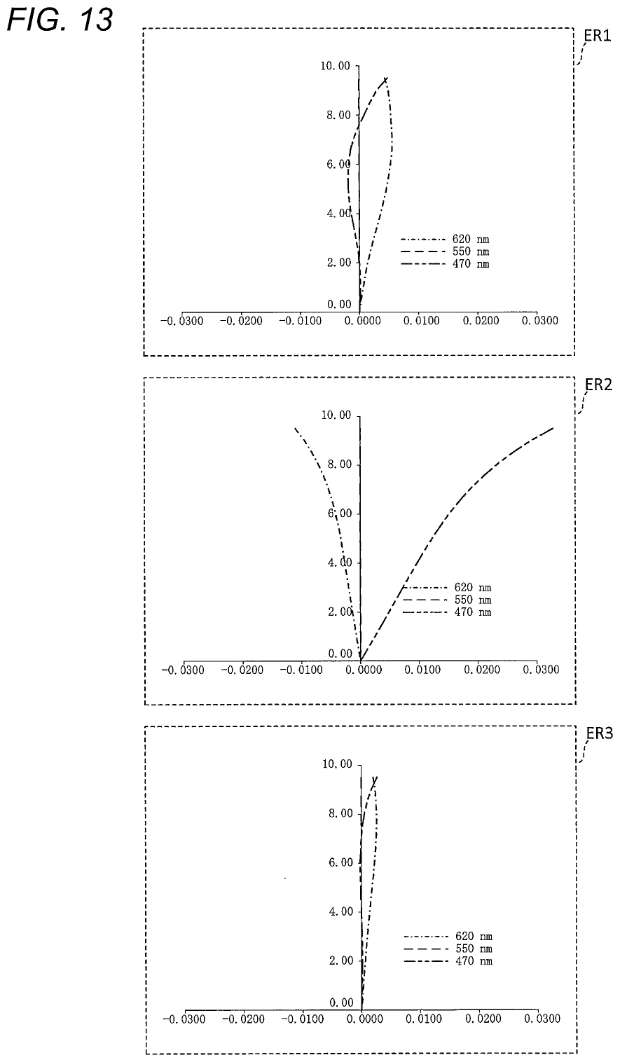

FIG. 13 shows the characteristics of the chromatic aberration of magnification of the multifocal lens according to Example 3. In FIG. 13, a region ER1 shows the characteristics of the chromatic aberration of magnification at the wide angle end (focal length fw=16.51 mm), a region ER2 shows the characteristics of the chromatic aberration of magnification in the intermediate region (focal length fm=24.70 mm), which is the intermediate position, and a region ER3 shows the characteristics of the chromatic aberration of magnification at the telephoto end (focal length ft=32.80 mm). The chromatic aberration of magnification of the multifocal lens according to Example 3 is characterized in that the larger one of the amount of aberration at the wide angle end and the amount of aberration at the telephoto end, that is, the amount of aberration at the wide angle end is smaller than the amount of aberration in the intermediate region between the wide angle end and the telephoto end.

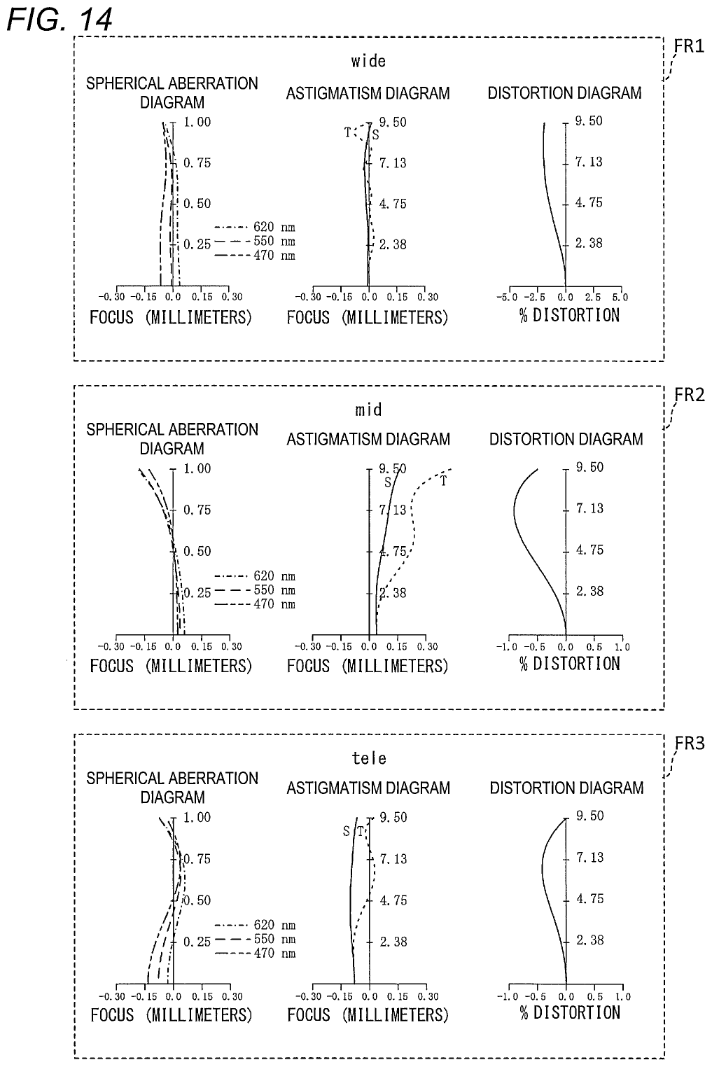

FIG. 14 shows the characteristics of the longitudinal aberrations (that is, characteristics of spherical aberration, astigmatism, and distortion) of the multifocal lens according to Example 3. In FIG. 14, a region FR1 shows the longitudinal aberrations at the wide angle end (focal length fw=16.51 mm), a region FR2 shows the longitudinal aberrations in the intermediate region (focal length fm=24.70 mm), which is the intermediate position, and a region FR3 shows the longitudinal aberrations at the telephoto end (focal length ft=32.80 mm). The spherical aberration of the multifocal lens according to Example 3 is characterized in that the larger one of the amount of aberration at the wide angle end and the amount of aberration at the telephoto end, that is, the amount of aberration at the telephoto end is smaller than the amount of aberration in the intermediate region between the wide angle end and the telephoto end. The astigmatism of the multifocal lens according to Example 3 is characterized in that the larger one of the amount of aberration at the wide angle end and the amount of aberration at the telephoto end, that is, the amount of aberration at the telephoto end is smaller than the amount of aberration in the intermediate region between the wide angle end and the telephoto end.

Table 10 below summarizes the values corresponding to Conditional Expressions (1) to (4) in Examples 1 to 3 for reference.

TABLE 10

| | Example 1 | Example 2 | Example 3 |
|---|---|---|---|
| Value fG1/fG2 of | −1.4 | −1.2 | −1.4 |
| Conditional Expression (1) | | | |
| Value M4/LL of | 0.200 | 0.172 | 0.308 |
| Conditional Expression (2) | | | |
| Value AVνd1/AVνd2 of | 0.67 | 0.67 | 0.67 |
| Conditional Expression (3) | | | |
| Value LL/H1 of | 5.78 | 5.78 | 7.75 |
| Conditional Expression (4) | | | |

### Second Embodiment

A multifocal lens according to a second embodiment of the present disclosure and an imaging apparatus incorporating the multifocal lens will be described below.

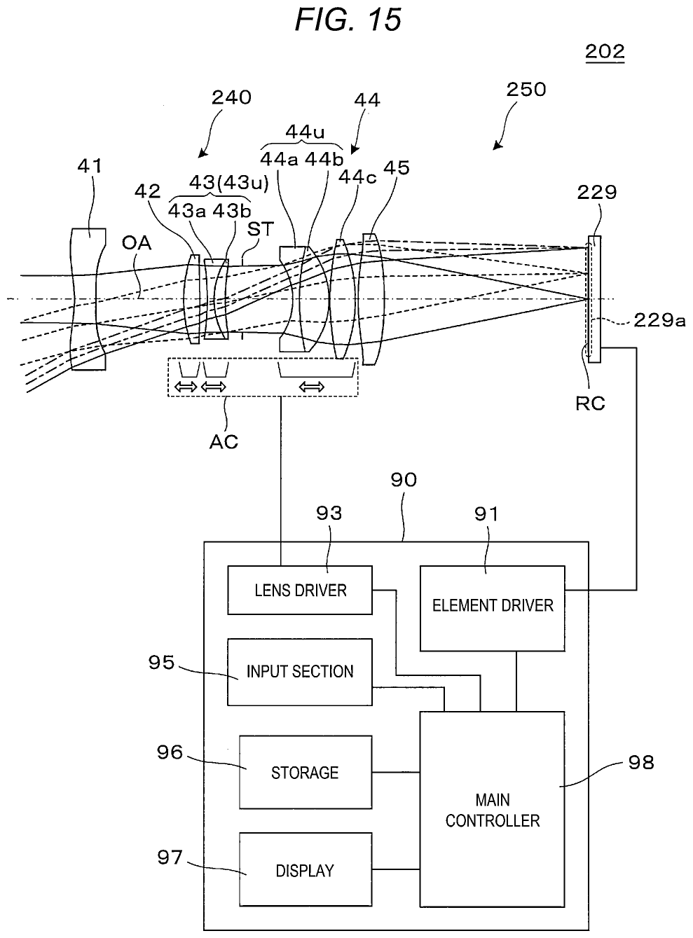

An imaging apparatus 202, which incorporates a multifocal lens 240 according to the second embodiment, includes an optical system section 250, which captures a target image, and a circuit apparatus 90, which controls the operation of the optical system section 250, as shown in FIG. 15.

The optical system section 250 includes the multifocal lens 240 and an imager 229. The multifocal lens 240 is the same as the multifocal lens 40 according to the first embodiment shown in FIG. 2. The imager 229 is, for example, a CMOS image sensor, and has a photoelectric converter 229a, and a signal processing circuit that is not shown is formed around the photoelectric converter 229a. In the photoelectric converter 229a, pixels, that is, photoelectric conversion elements are arranged two-dimensionally. The imager 229 is not limited to the CMOS image sensor described above, and may be an imager that incorporates another imager such as a CCD. The imager 229 or the photoelectric converter 229a are disposed in the reduction-side conjugate plane RC of the multifocal lens 240.

The circuit apparatus 90 includes an element driver 91, a lens driver 93, an input section 95, a storage 96, a display 97, and a main controller 98. The element driver 91 outputs control signals to a circuit and other elements associated with the imager 229 to operate the imager 229. The lens driver 93 operates under the control of the main controller 98, and can change the state of the multifocal lens 240 from the wide-angle-end state to the telephoto-end state and vice versa by appropriately moving some of the optical elements that constitute the multifocal lens 240 along the optical axis OA via the actuator AC. The input section 95 is a section that accepts the user's operation, the storage 96 is a section that stores information necessary for the operation of the imaging apparatus 202, image data acquired by the optical system section 250, and other pieces of information, and the display 97 is a section that displays information that should be presented to the user, a captured image, and other pieces of information. The main controller 98 harmoniously controls the operation of the element driver 91, the lens driver 93, the input section 95, the storage 96, the display 97, and other sections, and can perform various types of image processing on the image data acquired by the optical system section 250.

### Other Items

The structure described above is presented by way of example, and can be changed in a variety of manners to the extent that the same functions can be achieved.

For example, in each of Examples, one or more lenses having substantially no power can be added upstream and downstream from the lenses that constitute each of the lens groups.

Furthermore, a target to be enlarged and projected by the multifocal lens 40 is not limited to an image formed by a liquid crystal panel, and an image formed by a light modulator such as a digital micromirror device can be enlarged and projected.

### SUMMARY OF PRESENT DISCLOSURE

The present disclosure will be summarized below as additional remarks.

### Additional Remark 1

A multifocal lens configured with multiple lens groups and having a focal position changed by changing positions of the lens groups, wherein chromatic aberration of magnification of the multifocal lens is characterized in that a larger one of the amount of aberration at a wide angle end and the amount of aberration at a telephoto end is smaller than the amount of aberration in an intermediate region between the wide angle end and the telephoto end.

In the optical system that achieves the aforementioned characteristics of the chromatic aberration of magnification, the power of each of the lens groups can be increased, so that the travels of the lens groups for achieving multiple focal points can be suppressed. As a result, the performance of the multifocal lens can be maintained with an increase in the total length of the multifocal lens, that is, the lens length suppressed with respect to the image height, so that the size of the multifocal lens can be further reduced.

### Additional Remark 2

The multifocal lens according to the additional remark 1, including: a first lens group having negative refractive power; a second lens group having positive refractive power; a third lens group having negative refractive power; a fourth lens group having positive refractive power; and a fifth lens group having positive refractive power sequentially arranged from an enlargement side to a reduction side, wherein a portion facing the reduction side of the fifth lens group is a telecentric portion.

In the multifocal lens described above, the first lens group has negative refractive power, and the second lens group and the subsequent lens groups have positive refractive power as a whole, so that a wide viewing angle can be achieved with no increase in the diameter of the first lens group, and the back focal length of the multifocal lens can be increased. In addition, the chromatic aberration of magnification produced by the first lens group can be corrected by the second lens group, the positive chromatic aberration of magnification produced by the fourth lens group and the fifth lens group can be corrected by the negative power of the third lens group, and the telecentricity of the portion facing the reduction side of the fifth lens group can be secured by the fourth lens group and the fifth lens group, so that satisfactory aberration characteristics can be achieved.

### Additional Remark 3

The multifocal lens according to the additional remark 2, wherein at the time of zooming, the first lens group and the fifth lens group are fixed, and the second lens group, the third lens group, and the fourth lens group are moved independently of each other from the reduction side toward the enlargement side.

At the time of zooming, since the first lens group and the fifth lens group are fixed, and only the second lens group to the fourth lens group are moved independently of each other, the overall length of the multifocal lens does not change, and the structure of the lens barrel that holds the multifocal lens can be simplified.

### Additional Remark 4

The multifocal lens according to any one of the additional remarks 1 to 3, wherein spherical aberration is characterized in that a larger one of the amount of aberration at the wide angle end and the amount of aberration at the telephoto end is smaller than the amount of aberration in an intermediate region between the wide angle end and the telephoto end.

In the optical system that achieves the aforementioned characteristics of the spherical aberration, the lens power of each of the lens groups can be increased, so that the size of the multifocal lens can be further reduced. In particular, better aberration characteristics can be achieved at the wide angle end and the telephoto end.

### Additional Remark 5

The multifocal lens according to any one of the additional remarks 1 to 4, wherein a ratio of a focal length of the entire system at the telephoto end to the focal length of the entire system at the wide angle end is greater than or equal to 1.20.

The thus configured multifocal lens is a compact optical system including the multifocal lens having a short total length with respect to the image height, and having an increased focal length difference that is a difference in the focal length between the wide angle end and the telephoto end.

### Additional Remark 6

The multifocal lens according to any one of the additional remarks 2 to 5, satisfying a conditional expression below,

$$1. 0 \leq \vert fG 1 / fG 2 \vert , \qquad ( 1 )$$

where
fG1 represents a focal length of the first lens group, and
fG2 represents a focal length of the second lens group.

Making the power of the second lens group equal to or greater than that of the first lens group, that is, increasing the multifocal length difference (difference in magnification) contributes to a decrease in the total length, as in the multifocal lens described above.

### Additional Remark 7

The multifocal lens according to any one of the additional remarks 2 to 6, satisfying a conditional expression below,

$$0. 10 \leq M 4 / LL \leq 0.35 , \qquad ( 2 )$$

where
M4 represents a travel of the fourth lens group from the wide angle end to the telephoto end, and
LL represents a lens length.

Making the travel of the fourth lens group relatively large can contribute to a decrease in the entire length while increasing the multifocal length difference (difference in magnification), as in the multifocal lens described above. Setting the value M4/LL in Conditional Expression described above to be greater than or equal to the lower limit readily increases the multifocal length difference (difference in magnification). Setting the value M4/LL in Conditional Expression described above to be smaller than or equal to the upper limit can avoid the problems of an increase in the overall length and increases in the variety of aberrations. The state in which a diaphragm is disposed between the third lens group and the fourth lens group and the travel of the fourth lens group is large can be typically taken as a large travel of the portion downstream from the diaphragm, that is, the reduction-side portion of the multifocal lens.

### Additional Remark 8

The multifocal lens according to any one of the additional remarks 2 to 7, satisfying a conditional expression below,

$$AVvd 1 / AVvd 2 \leq 0.8 , \qquad ( 3 )$$

where
AVνd1 represents an average Abbe number of the first lens group at a d-line, and
AVνd2 represents an average Abbe number of the second lens group at the d-line.

In the multifocal lens described above, the size reduction can be achieved with the chromatic aberration effectively corrected. When the second lens group is a single lens, the size reduction can be more readily achieved.

### Additional Remark 9

The multifocal lens according to any one of the additional remarks 1 to 8, satisfying a conditional expression below,

$$LL / HI \leq 8. , \qquad ( 4 )$$

where
LL represents a lens length, and
HI represents an image height.

Satisfying Conditional Expression described above can contribute to the reduction in the size of the multifocal lens.

### Additional Remark 10

A projector including:
the multifocal lens according to any one of the additional remarks 1 to 9; and
an image forming section configured to form a projection image in a reduction-side conjugate plane of the multifocal lens,
wherein the image forming section includes a light source apparatus and a light modulator configured to modulate light from the light source apparatus.

The size of the projector including the multifocal lens can thus be reduced.

### Additional Remark 11

An imaging apparatus including:
the multifocal lens according to any one of the additional remarks 1 to 9; and
an imager disposed in a reduction-side conjugate plane of the multifocal lens.

The size of the imaging apparatus including the multifocal lens can thus be reduced.

What is claimed is:

1. A multifocal lens configured with multiple lens groups and having a focal position changed by changing positions of the lens groups,
wherein chromatic aberration of magnification of the multifocal lens is characterized in that a larger one of the amount of aberration at a wide angle end and the amount of aberration at a telephoto end is smaller than the amount of aberration in an intermediate region between the wide angle end and the telephoto end.

2. The multifocal lens according to claim 1, comprising: a first lens group having negative refractive power; a second lens group having positive refractive power; a third lens group having negative refractive power; a fourth lens group having positive refractive power; and a fifth lens group having positive refractive power sequentially arranged from an enlargement side to a reduction side,
wherein a portion facing the reduction side of the fifth lens group is a telecentric portion.

3. The multifocal lens according to claim 2,
wherein at the time of zooming, the first lens group and the fifth lens group are fixed, and
the second lens group, the third lens group, and the fourth lens group are moved independently of each other from the reduction side toward the enlargement side.

4. The multifocal lens according to claim 1,
wherein spherical aberration is characterized in that a larger one of the amount of aberration at the wide angle end and the amount of aberration at the telephoto end is smaller than the amount of aberration in an intermediate region between the wide angle end and the telephoto end.

5. The multifocal lens according to claim 1,
wherein a ratio of a focal length of the entire system at the telephoto end to the focal length of the entire system at the wide angle end is greater than or equal to 1.20.

6. The multifocal lens according to claim 2, satisfying a conditional expression below,
$$1. 0 \leq \vert fG 1 / fG 2 \vert , \qquad ( 1 )$$
where
fG1 represents a focal length of the first lens group, and
fG2 represents a focal length of the second lens group.

7. The multifocal lens according to claim 2, satisfying a conditional expression below,
$$0. 10 \leq M 4 / LL \leq 0.35 , \qquad ( 2 )$$
where
M4 represents a travel of the fourth lens group from the wide angle end to the telephoto end, and
LL represents a lens length.

8. The multifocal lens according to claim 2, satisfying a conditional expression below,
$$AVvd 1 / AVvd 2 \leq 0.8 , \qquad ( 3 )$$
where
AVνd1 represents an average Abbe number of the first lens group at a d-line, and
AVνd2 represents an average Abbe number of the second lens group at the d-line.

9. The multifocal lens according to claim 1, satisfying a conditional expression below,
$$LL / HI \leq 8. , \qquad ( 4 )$$
where
LL represents a lens length, and
HI represents an image height.

10. A projector comprising:
the multifocal lens according to claim 1; and
an image forming section configured to form a projection image in a reduction-side conjugate plane of the multifocal lens,
wherein the image forming section includes a light source apparatus and a light modulator configured to modulate light from the light source apparatus.

11. An imaging apparatus comprising:
the multifocal lens according to claim 1; and
an imager disposed in a reduction-side conjugate plane of the multifocal lens.
